(19) United States
(12) Patent Application Publication
(10) Pub. No.: US 2024/0344630 A1
(43) Pub. Date: Oct. 17, 2024

(54) DETECTING VALVE LEAKAGE

(71) Applicant: Saudi Arabian Oil Company, Dhahran (SA)

(72) Inventors: Keith William Brashler, Dhahran (SA); Ali Al Shehri, Thuwal (SA); Mohammad Al-Ba’adani, Jeddah (SA); Doru Catalin Turcan, Dhahran (SA)

(21) Appl. No.: 18/301,133

(22) Filed: Apr. 14, 2023

(51) Int. Cl. F16K 37/00

(52) U.S. Cl. CPC F16K 37/0041; F16K 37/005

(57) ABSTRACT

A valve assembly that includes a first sensor, multiple sensors, and a system. The first sensor generates, when attached to a valve in a closed position and in a passing condition, first sensor feedback including vibration information. The multiple sensors generate second sensor feedback. The system includes one or more computers that receive the first sensor feedback and second sensor feedback and determine, as a function of the second sensor feedback, a temperature differential between an inlet of the valve and an outlet of the valve. The one or more computers compare the vibration information and temperature differential to at least one threshold, and determine that at least one of the vibration information or temperature differential satisfies the at least one threshold. The one or more computers provide, to a receiver, information including an indication of a passing condition of the valve.

### FIELD OF THE DISCLOSURE

This disclosure relates to mechanical valves.

### BACKGROUND OF THE DISCLOSURE

Valves are used in piping systems to close, open, or regulate the flow of fluids in pipes. Some valves are used to form a fluid seal between an inlet of the valve and an outlet of the valve. Forming a fluid seal prevents fluids from leaking across the valve, allowing the valve to interrupt the fluid flow within a pipe. Wear, corrosion, erosion, obstructions, calibration errors, and other issues can lead to valve leaks, creating a passing condition in which fluid passes through the valve when the valve is closed. Methods and equipment to improve the detection of leaks in valves are sought.

### SUMMARY

Implementations of the present disclosure include a valve assembly that includes a first sensor, multiple sensors, and a system. The first sensor generates, when attached to a valve in a closed position and in a passing condition, first sensor feedback including vibration information of the valve. The multiple sensors generate, when residing at or near the valve in the closed position and the valve being in a passing condition, second sensor feedback. The system includes one or more computers in one or more locations and one or more storage devices storing instructions that are operable, when executed by the one or more computers, to cause the one or more computers to perform operations. The operations include receiving the first sensor feedback from the first sensor and receiving the second sensor feedback from the multiple sensors. The operations include determining, as a function of the second sensor feedback, a temperature differential between an inlet of the valve and an outlet of the valve. The operations include comparing the vibration information and temperature differential to at least one threshold. The operations include determining, as a function of the comparing, that at least one of the vibration information or temperature differential satisfies the at least one threshold. The operations include providing, to a receiver and as a function of the determination, information including an indication of a passing condition of the valve.

In some implementations, the first sensor is configured to generate, when attached to the valve in the closed position and in a non-passing condition, third sensor feedback including baseline vibration information of the valve. The multiple sensors are configured to generate, when residing at or near the valve in the closed position and in the non-passing condition, fourth sensor feedback. The operations further include, before receiving the first sensor feedback, receiving the third sensor feedback from the first sensor and receiving the fourth sensor feedback from the multiple sensors. The operations also include determining, as a function of the fourth sensor feedback, a baseline temperature differential between an inlet of the valve and an outlet of the valve. The operations also include determining, as a function of the third sensor feedback and the baseline temperature differential, the at least one threshold.

In some implementations, the operations further include, before receiving the first sensor feedback: receiving, from a valve position sensor coupled to the valve, fifth sensor feedback including information indicating that the valve is closed. The determining of the at least one threshold includes determining the at least one threshold as a function of i) the fifth sensor feedback, ii) the third sensor feedback, and iii) the baseline temperature differential.

In some implementations, the system includes a machine learning processing system that processes the third sensor feedback and fourth sensor feedback to fine-tune, based on a machine learning algorithm, the at least one threshold.

In some implementations, the operations further include receiving, from a valve position sensor coupled to the valve, fifth sensor feedback, and determining, as a function of the fifth sensor feedback, that the valve is closed. The determination includes determining, as a function of the fifth sensor feedback and as a function of the comparing, that a combination of the vibration information and the temperature differential satisfies the at least one threshold.

In some implementations, the combination includes fused data of the vibration information and the temperature differential.

In some implementations, the assembly also includes a pressure sensor configured to generate, when coupled to or near the valve in a closed position and in a passing condition, sixth sensor feedback. The operations further include receiving, from the pressure sensor, the sixth sensor feedback. The operations further include determining, as a function of the sixth sensor feedback, a pressure fluctuation of a fluid at an outlet of the valve. The operations further include comparing a combination of the vibration information, temperature differential, and the pressure fluctuation, to the at least one threshold. The operations further include determining, as a function of the comparing, that the combination satisfies the at least one threshold.

In some implementations, the at least one threshold includes a vibration threshold that corresponds with the vibration information, a temperature differential threshold that corresponds with the temperature differential, and a pressure fluctuation threshold that corresponds with the pressure fluctuation. Determining that the combination satisfies the at least one threshold includes determining that at least two of the i) vibration information, ii) temperature differential, or iii) pressure fluctuation satisfies its corresponding threshold.

In some implementations, the pressure sensor includes a dynamic pressure sensor residing downstream of valve seats of the valve. The dynamic pressure sensor senses ultrasound frequencies associated with early stages of a passing condition of the valve.

In some implementations, the system includes a machine learning processing system configured to process information from the first sensor and multiple sensors to fine tune, based on a machine learning algorithm, the comparing for the determination that at least one of the vibration information or temperature differential satisfies the at least one threshold.

In some implementations, the first sensor includes a radio frequency Nano-sensor that detects a frequency range of between 0 and 1000 Hz.

Implementations of the present disclosure also include a method of detecting leakage or a passing condition. The method includes receiving, by a system including one or more computers in one or more locations, first sensor feedback from a sensor attached to a valve in a closed position and in a passing condition. The first sensor feedback includes vibration information of the valve. The method also includes receiving, by the system, second sensor feedback from a multiple sensors coupled to the valve in the closed position and in the passing condition. The method also includes determining, by the system and as a function of the second sensor feedback, a temperature differential between an inlet of the valve and an outlet of the valve. The method also includes comparing, by the system, a combination of the vibration information and temperature differential to at least one threshold. The method also includes determining, by the system and as a function of the comparison, that the combination satisfies the at least one threshold. The method also includes providing, by the system and to a receiver and as a function of determining that the combination satisfies the threshold, information including an indication of a valve passing condition.

In some implementations, the first sensor is configured to generate, when attached to the valve in the closed position and in a non-passing condition, third sensor feedback including baseline vibration information of the valve. The multiple sensors are configured to generate, when residing at or near the valve in the closed position and in the non-passing condition, fourth sensor feedback. The method further includes receiving the third sensor feedback from the first sensor and receiving the fourth sensor feedback from the multiple sensors. The method also includes determining, by the system, as a function of the fourth sensor feedback, a baseline temperature differential between an inlet of the valve and an outlet of the valve. The method also includes determining, by the system, as a function of the third sensor feedback and the baseline temperature differential, the at least one threshold.

In some implementations, the method also includes receiving, by the system and from a pressure sensor, sixth sensor feedback. The pressure sensor generates, when coupled to or near the valve in a closed position and in a passing condition, the sixth sensor feedback. The method also includes determining, by the system, as a function of the sixth sensor feedback, a pressure fluctuation of a fluid at an outlet of the valve. The method also includes comparing, by the system, a combination of the vibration information, temperature differential, and the pressure fluctuation to the at least one threshold. The method also includes determining, as a function of the comparing, that the combination satisfies the at least one threshold.

Implementations of the present disclosure also include a system that includes one or more computers and one or more storage devices on which are stored instructions that are operable, when executed by the one or more computers, to cause the one or more computers to perform operations including: receive first sensor feedback from a sensor attached to a valve in a closed position and in a passing condition, the first sensor feedback including vibration information of the valve. The operations also include receiving second sensor feedback from a multiple sensors coupled to the valve in the closed position and in the passing condition. The operations also include determining, as a function of the second sensor feedback, a temperature differential between an inlet of the valve and an outlet of the valve. The operations also include comparing a combination of the vibration information and temperature differential to at least one threshold. The operations also include determining, as a function of the comparison, that the combination satisfies the at least one threshold. The operations also include providing, to a receiver and as a function of determining that the combination satisfies the threshold, information including an indication of a valve passing condition.

### BRIEF DESCRIPTION OF THE DRAWINGS

FIG. 1 is a perspective, schematic view of a valve assembly according to an embodiment of the present disclosure.

FIG. 2 is a partially cross-sectional, schematic view of a portion of a valve in an open position.

FIG. 3 is a partially cross-sectional, schematic view of the portion of the valve in FIG. 2, in a closed position and with a passing condition.

FIG. 4 is a flow chart of an example method of using a pipe assembly.

FIG. 5 is a schematic illustration of an example control system or controller according to an embodiment of the present disclosure.

### DETAILED DESCRIPTION OF THE DISCLOSURE

The present disclosure describes an early detection system used to identify a passing condition (e.g., leakage) in a valve such as a process control valve, a pump recycle valve, or a different type of mechanical valve. The detection system includes multiple sensors that detect vibration response of the valve, differential temperature, and pressure to identify a passing condition. The system also incorporates valve positioner feedback to indicate that the valve is in a closed position. The system also uses a processor with machine learning algorithms to fine-tune the calculations and determinations of the system. The system uses feedback from all sensors and determines the baseline signature with the valve in the closed position with no passing conditions. This baseline signature is used to determine a threshold based on a deviation from the baseline values. By comparing the sensor feedback to the threshold values, the system determines whether the results of the comparison constitute the onset of a valve passing condition. The detection system can be implemented in other embodiments such as in safety-critical and hazardous duty valves, or boiler feedwater systems. In a boiler feedwater installations, the system can detect a valve passing condition of the pump's minimum flow recycle valve, which is a normally closed valve.

Particular implementations of the subject matter described in this specification can be implemented so as to realize one or more of the following advantages. For example, the pipe assembly of the present disclosure can anticipate or prevent the failure of valves, which can save time and resources. Additionally, the pipe assembly of the present disclosure can lead to energy savings related to pumping systems with passing recycle valves. Additionally, the pipe assembly of the present disclosure can prevent contamination caused by passing conditions, which can increase safety and reduce or eliminate environmental hazards.

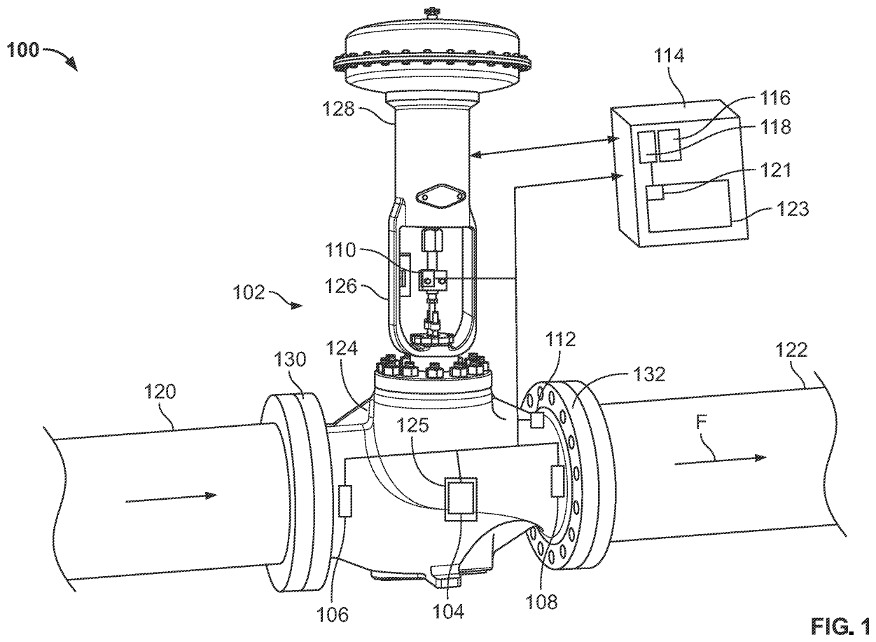

FIG. 1 shows a valve assembly 100 that includes a valve 102, a computer system 114, and multiple sensors 104, 106, 108, 110, 112 electrically coupled to (or part of) the computer system 114 (e.g., a detection system). The sensors include one or more sensors 104 that sense vibration (e.g., a vibration sensor), two or more sensors 106, 108 that sense temperature (e.g., temperature sensors), one or more sensors 110 that indicate the position of the valve (e.g., a valve position sensor), and one or more sensors 112 that sense fluid pressure (e.g., a pressure sensor).

The valve 102 can be any type of mechanical valve with a valve plug such as a process control valve (e.g., a gate valve, a butterfly valve, etc.) or a pump recycle valve. The valve 102 includes a body 124, a yoke assembly 126, and an actuator assembly 128. The yoke assembly 126 can include a yoke, a valve stem, a bonnet, etc. The actuator assembly 128 can include an actuator that moves the valve plug or gate, an actuator spring, a diaphragm, a diaphragm case, etc.

The valve 102 is attached to a pipe that directs a fluid “F” (e.g., process fluid such as hydrocarbons). For example, the body 124 has an inlet 130 attached to a first pipe 120 (e.g., an upstream pipe) and an outlet 132 attached to a second pipe 122 (e.g., a downstream pipe). The fluid from the first pipe 120 enters the valve 102 through the inlet 130 and leaves the valve 102 through the outlet 132 to flow to the second pipe 122.

The system 114 has one or more processors 116 that receive and process the sensor feedback. The system 114 can also have one or more controllers 118 electrically coupled to the valve 102 to control (e.g., open and close) the valve 102. The system 114 uses the sensor feedback to determine a passing condition or a likelihood of the valve developing a passing condition. For example, the system 114 analyses sensor feedback to determine if the valve 102 is closed and, based on the data received from the sensors when the valve 102 is closed, determine if the valve 102 has a passing condition. The system 114 can also determine whether the valve 102 is likely to develop a passing condition and/or a degree (e.g., a level or percentage) of a passing condition. A passing condition is referred to herein as a condition in which the valve is closed (e.g., the plug of the valve is at the valve seats to form a fluid seal) and fluid is still passing from the inlet 130 to the outlet 132 of the valve 102.

In some implementations, the system 114 can be implemented as a distributed computer system disposed partly at the valve 102 and partly at a remote location away from the valve 102. The computer system can include one or more processors 116 and a computer-readable medium storing instructions executable by the one or more processors 116 to perform the operations described here. In some implementations, the system 114 can be implemented as processing circuitry, firmware, software, or combinations of them. The system 114 can include or transmit signals to a receiver 121 of a user interface 123 (e.g., an electronic display) that displays an indication of a passing condition. In some cases, the controller 118 can trigger an alarm or an illumination source that indicates a passing condition.

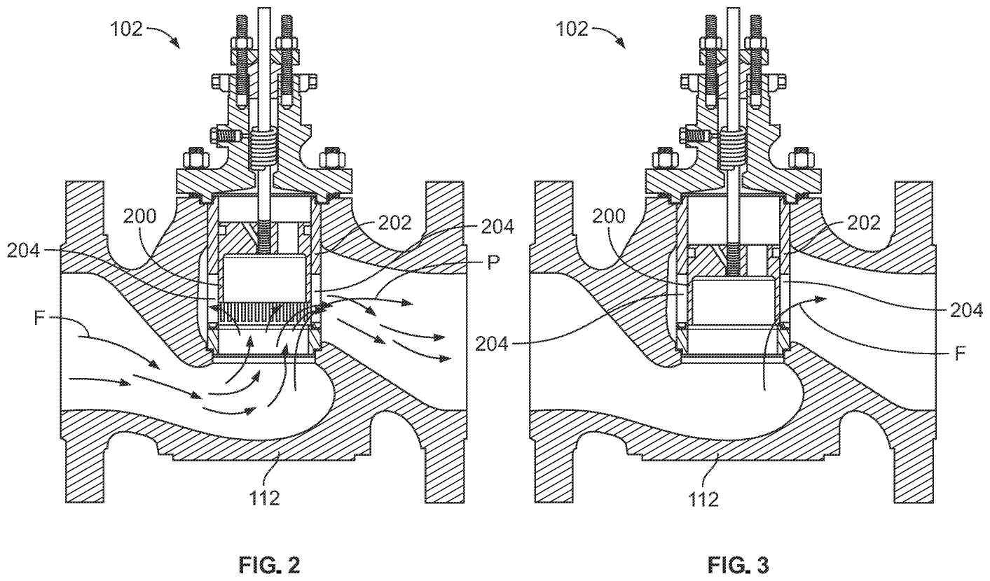

The vibration sensor 104 can be attached to an external surface of the valve body 124 or can be embedded in the valve 102 (e.g., inside the valve 102). The vibration sensor 104 resides near valve seats 202 (shown in FIG. 2) to detect the vibration near the seats and generate feedback that represents the vibration of the valve 102. The vibration sensor 104 can be a Nano-sensor such as a micro electro-mechanical system (MEMS) sensor. The sensor 104 can be a piezoelectric-based sensor that uses aluminum nitride as piezoelectric material. The sensor 104 can have Nano-tubes that allow the sensor to feature high sensitivity and a wide frequency response. For example, the sensor 104 can detect a frequency range of between 0 and 115 KHz. Thus, the sensor 104 can provide better results for early detection of valve passing conditions compared to a traditional vibration sensor.

The temperature sensors 106, 108 can be attached to an external surface of the valve or can be embedded within the valve 102. The temperature sensors 106, 108 include an upstream temperature sensor 106 and a downstream temperature sensor 108. The upstream temperature sensor 106 is attached to the valve 102 or the first pipe 120 upstream of the valve seats, and the downstream sensor 108 is attached to the valve 102 or the second pipe 122 downstream of the valve seats. The system 114 determines a differential temperature across the valve 102 by determining a difference between the temperatures sensed by the two sensors 106, 108.

The pressure sensor 112 can be attached to an external surface of the valve body 124 (e.g., at the downstream pressure tap of the valve) or can be embedded in the valve 102. The pressure sensor 112 can be a dynamic pressure sensor that measures the pressure fluctuations (as opposed to the static pressure) of the fluid “F.” Additionally, the pressure sensor 112 can measure frequencies in excess of 100 kHz. The ultrasound waves are generated by the flow around the passing valve seat. Thus, these waves are first propagated through the fluid “F” and then transmitted to the valve body and to the surroundings, where the pressure sensor 112 can detect the waves. The ultrasound waves have low amplitudes which can be attenuated while propagating to a media or when encountering a boundary between media. The dynamic pressure sensor 112 measures pressure pulsations that are indicative of the early stages of a passing condition. For example, the pressure pulsations (e.g., liquid pressure pulsation within the valve) have high frequencies (e.g., between 0.2 and 100 kHz) and low amplitudes (e.g., between 0 and 70 dB), which indicate the onset of a passing condition.

In some implementations, one or more of the sensors 104, 106, 108, 110, 112 are protected by high-temperature sensor packaging 125. The high-temperature sensor packaging 125 can be or include a matrix for encapsulation that protects the respective sensor against harsh environment conditions. For example, the sensor packaging 125 can include a first layer of steel followed by a layer of epoxy.

FIGS. 2 and 3 show the valve 102 open and closed, respectively. As shown in FIG. 2, the valve 102 has a plug 200 that, when lifted, opens a fluid pathway “P” that extends through the opening 204 formed by the valve seats 202. As shown in FIG. 3, when the plug 200 is lowered, the plug 200 closes the fluid pathway “P.” During a passing condition, the fluid “F” passes through the lowered plug 200 to the outlet of the valve 102. The passing condition may be due to worn out valve seats 202, corrosion of the plug 200, etc.

Referring back to FIG. 1, the system 114 can determine thresholds as a function of the sensor feedback in a non-passing condition. To determine the thresholds, the system 114 first determines, based on the feedback from the valve position sensor 110, that the valve is in the closed position. Once the system 114 determines that the valve 102 is closed and without a passing condition (e.g., upon installation of the valve 102 or otherwise verifying that no fluid is passing through the valve), the system 114 receives feedback from the vibration sensor 104 that includes vibration information of the valve 102. The vibration information includes, for example, a baseline frequency that is lower than a frequency when the valve has a passing condition. The system 114 can use the baseline frequency as (or to set) a frequency threshold that, if exceeded, can indicate a passing condition.

Moreover, when the valve 102 is closed without a passing condition, the system 114 can also determine a temperature differential threshold. For example, the system 114 receives feedback from the temperature sensors 106, 108 that includes upstream temperature and downstream temperature of the fluid “F” or the valve 102 or pipes. The temperature differential between the upstream and downstream temperatures includes, for example, a baseline temperature differential that is higher than a temperature differential when the valve has a passing condition. Because the temperature differential reduces with a passing condition (e.g., fluid passing though the plug is the same temperature as the fluid upstream of the plug), the system 114 can use the baseline temperature differential as a threshold that, if met, can indicate a passing condition.

Furthermore, when the valve 102 is closed without a passing condition, the system 114 can also determine a pressure threshold. For example, the system 114 receives feedback from the pressure sensor 112 that includes pressure information of the fluid “F” or the valve 102. The pressure information includes, for example, a baseline pressure or frequency that is lower than a pressure or frequency when the valve 102 has a passing condition. The system 114 can use the baseline pressure as a pressure threshold that, if exceeded, can indicate a passing condition.

Once the thresholds are determined, the system 114 determines, when the valve 102 is closed, if the sensor feedback (e.g., real-time feedback) satisfies the determined thresholds. For example, once the system 114 determines that the valve 102 is closed (based on the feedback from the valve position sensor 110), the system 114 receives and analyses the feedback from the vibration sensor 104, the temperature sensors 106, 108, and the pressure sensor 112 to detect a passing condition.

For example, the system 114 can compare the vibration information from the vibration sensor 104 to the predetermined vibration threshold and the pressure information from the pressure sensor 112 to the predetermined pressure threshold. The system 114 can also determine the temperature differential between the two temperature sensors 106, 108, and compare the temperature differential to the predetermined temperature differential threshold. If one, two, or more thresholds are met, the system 114 determines that there is a passing condition (or a probability of a passing condition) and alerts a user by triggering an alarm or transmitting information to the user interface 123 including an indication of a passing condition of the valve 102. In some implementations, the system 114 can determine increasing levels of a passing condition as more thresholds are met. In some implementations, the system 114 can establish multiple vibration thresholds, pressure thresholds, and temperature thresholds based on the baseline readings to determine a level (or likelihood) of passing condition as each of the multiple vibration, pressure, and temperature thresholds (or a combination of the thresholds) are met.

In some implementations, the system 114 uses machine learning and data fusion to determine whether the valve 102 has a passing condition. For example, the system 114 can use an integration or combination of the vibration information, temperature information, and pressure information to determine whether the valve 102 has a passing condition. The system 114 compares the combination of sensor feedback to one or more of the predetermined thresholds or to a combination of the predetermined thresholds. For example, the system 114 can determine that the valve 102 has a passing condition only if the system 114 determines that an increase in vibration response is consistent with a change in differential temperature and/or a change of dynamic pressure.

The system 114 can also use artificial intelligence such as machine-learning algorithms to identify the passing condition. For example, the processor 116 can include a processing system that includes a machine-learning process (e.g., a deep learning process implemented, for example, using a similarity metric or a classifier such as support vector machine or a neural network) used to fine-tune, based on a machine learning algorithm, the process of comparing the sensor feedback to the thresholds and determining whether there is a passing condition. For example, the system 114 can use machine-learning processes to fine-tune the thresholds and the integration of the sensor feedback to more accurately identify a passing condition.

Specifically, the machine learning system can be used to establish the baseline signatures for the valve in the closed position and without a passing condition. The machine learning system can also be used to establish a comparison signature for a slight passing condition. This may be accomplished by opening the valve slightly to establish a signature when the valve is passing in terms of both temperature differential and vibration response. The machine learning system helps provide what the signatures look like when the valve seats begin to start passing. Once the seats start to pass the wear rate will increase rapidly, therefore, the machine learning aspect will help identify the precise onset of signature change that identifies the passing condition.

The machine learning system can help determine which parameter is most likely to indicate a passing condition, and fine-tune that parameter's threshold or the combination of the sensor feedbacks.

Additionally, the machine learning system can analyze previous passing conditions and maintenance history of the seats to determine threshold values and promote early detection of a valve passing condition. Additionally, following any maintenance or overhaul activity to repair the valve (i.e. replace worn seats), the machine learning system can adjust the threshold values based on new vibration, temperature, and pressure associated with the newly maintained valve and new seats. After a few repair cycles to repair worn valve seats, the machine learning algorithms can be modified and the threshold values can be fine-tuned to optimize the maintenance planning for triggering overhaul of the valve.

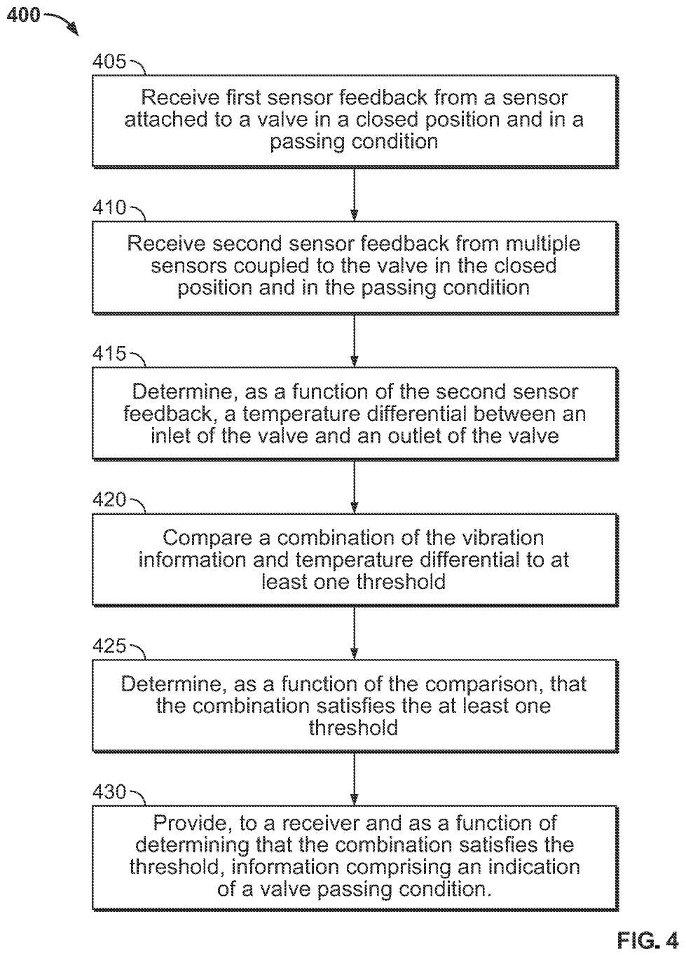

FIG. 4 is a flow chart of an example method 400 of detecting a valve passing condition. The method includes receiving, by a system comprising one or more computers in one or more locations, first sensor feedback from a sensor attached to a valve in a closed position and in a passing condition. The first sensor feedback includes vibration information of the valve (405). The method also includes receiving, by the system, second sensor feedback from multiple sensors coupled to the valve in the closed position and in the passing condition (410). The method also includes determining, by the system and as a function of the second sensor feedback, a temperature differential between an inlet of the valve and an outlet of the valve (415). The method also includes comparing, by the system, a combination of the vibration information and temperature differential to at least one threshold (420). The method also includes determining, by the system and as a function of the comparison, that the combination satisfies the at least one threshold (425). The method also includes providing, by the system and to a receiver and as a function of determining that the combination satisfies the threshold, information comprising an indication of a valve passing condition (430).

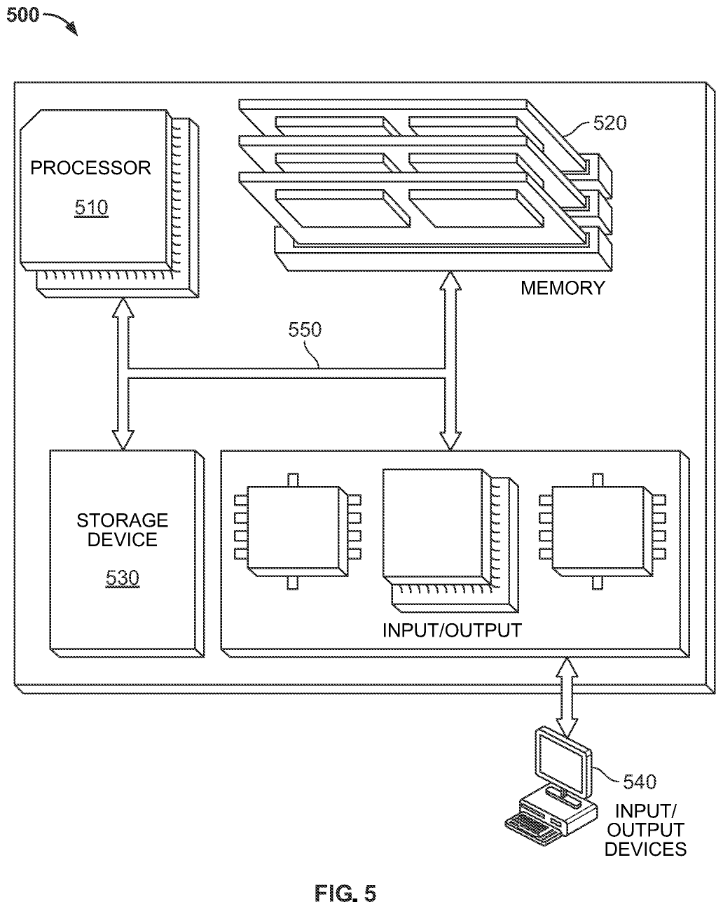

FIG. 5 is a schematic illustration of an example computer system for a leakage detection system according to the present disclosure. For example, the system 500 may include or be part of the system 114 shown in FIG. 1. The system 500 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

Although the following detailed description contains many specific details for purposes of illustration, it is understood that one of ordinary skill in the art will appreciate that many examples, variations and alterations to the following details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

What is claimed is:

1. A valve assembly, comprising:
a first sensor configured to generate, when attached to a valve in a closed position and in a passing condition, first sensor feedback comprising vibration information of the valve;
a plurality of sensors configured to generate, when residing at or near the valve in the closed position and in the passing condition, second sensor feedback; and
a system comprising one or more computers in one or more locations and one or more storage devices storing instructions that are operable, when executed by the one or more computers, to cause the one or more computers to perform operations comprising:
receiving the first sensor feedback from the first sensor;
receiving the second sensor feedback from the plurality of sensors;
determining, as a function of the second sensor feedback, a temperature differential between an inlet of the valve and an outlet of the valve;
comparing the vibration information and temperature differential to at least one threshold;
determining, as a function of the comparing, that at least one of the vibration information or temperature differential satisfies the at least one threshold; and
providing, to a receiver and as a function of the determination, information comprising an indication of a passing condition of the valve.

2. The valve assembly of claim 1, wherein the first sensor is configured to generate, when attached to the valve in the closed position and in a non-passing condition, third sensor feedback comprising baseline vibration information of the valve, and the plurality of sensors are configured to generate, when residing at or near the valve in the closed position and in the non-passing condition, fourth sensor feedback, the operations further comprising, before receiving the first sensor feedback:
receiving the third sensor feedback from the first sensor;
receiving the fourth sensor feedback from the plurality of sensors;
determining, as a function of the fourth sensor feedback, a baseline temperature differential between an inlet of the valve and an outlet of the valve; and
determining, as a function of the third sensor feedback and the baseline temperature differential, the at least one threshold.

3. The valve assembly of claim 2, wherein the operations further comprise, before receiving the first sensor feedback:
receiving, from a valve position sensor coupled to the valve, fifth sensor feedback comprising information indicating that the valve is closed;
wherein the determining of the at least one threshold comprises determining the at least one threshold as a function of i) the fifth sensor feedback, ii) the third sensor feedback, and iii) the baseline temperature differential.

4. The valve assembly of claim 2, wherein the system comprises a machine learning processing system configured to process the third sensor feedback and fourth sensor feedback to fine-tune, based on a machine learning algorithm, the at least one threshold.

5. The valve assembly of claim 1, the operations further comprising:
receiving, from a valve position sensor coupled to the valve, fifth sensor feedback; and
determining, as a function of the fifth sensor feedback, that the valve is closed;
wherein the determination comprises determining, as a function of the fifth sensor feedback and as a function of the comparing, that a combination of the vibration information and the temperature differential satisfies the at least one threshold.

6. The valve assembly of claim 5, wherein the combination comprises fused data of the vibration information and the temperature differential.

7. The valve assembly of claim 1, further comprising a pressure sensor configured to generate, when coupled to or near the valve in a closed position and in a passing condition, sixth sensor feedback, the operations further comprising:
receiving, from the pressure sensor, the sixth sensor feedback;
determining, as a function of the sixth sensor feedback, a pressure fluctuation of a fluid at an outlet of the valve;
comparing a combination of the vibration information, temperature differential, and the pressure fluctuation, to the at least one threshold;
determining, as a function of the comparing, that the combination satisfies the at least one threshold.

8. The valve assembly of claim 7, wherein the at least one threshold comprises a vibration threshold that corresponds with the vibration information, a temperature differential threshold that corresponds with the temperature differential, and a pressure fluctuation threshold that corresponds with the pressure fluctuation, and determining that the combination satisfies the at least one threshold comprises determining that at least two of the i) vibration information, ii) temperature differential, or iii) pressure fluctuation satisfies its corresponding threshold.

9. The valve assembly of claim 7, wherein the pressure sensor comprises a dynamic pressure sensor residing downstream of valve seats of the valve, the dynamic pressure sensor configured to sense ultrasound frequencies associated with early stages of a passing condition of the valve.

10. The valve assembly of claim 1, wherein the system comprises a machine learning processing system configured to process information from the first sensor and plurality of sensors to fine tune, based on a machine learning algorithm, the comparing for the determination that at least one of the vibration information or temperature differential satisfies the at least one threshold.

11. The valve assembly of claim 1, wherein the first sensor comprises a radio frequency Nano-sensor, the radio frequency Nano-sensor configured to detect a frequency range of between 0 and 1000 Hz.

12. A method, comprising:
receiving, by a system comprising one or more computers in one or more locations, first sensor feedback from a sensor attached to a valve in a closed position and in a passing condition, the first sensor feedback comprising vibration information of the valve;
receiving, by the system, second sensor feedback from a plurality of sensors coupled to the valve in the closed position and in the passing condition;
determining, by the system and as a function of the second sensor feedback, a temperature differential between an inlet of the valve and an outlet of the valve;
comparing, by the system, a combination of the vibration information and temperature differential to at least one threshold;
determining, by the system and as a function of the comparison, that the combination satisfies the at least one threshold; and
providing, by the system and to a receiver and as a function of determining that the combination satisfies the threshold, information comprising an indication of a valve passing condition.

13. The method of claim 12, wherein the first sensor is configured to generate, when attached to the valve in the closed position and in a non-passing condition, third sensor feedback comprising baseline vibration information of the valve, and the plurality of sensors are configured to generate, when residing at or near the valve in the closed position and in the non-passing condition, fourth sensor feedback, the method further comprising:
receiving, by the system, the third sensor feedback from the first sensor;
receiving, by the system, the fourth sensor feedback from the plurality of sensors;
determining, by the system, as a function of the fourth sensor feedback, a baseline temperature differential between an inlet of the valve and an outlet of the valve; and
determining, by the system, as a function of the third sensor feedback and the baseline temperature differential, the at least one threshold.

14. The method of claim 12, further comprising receiving, by the system and from a pressure sensor, sixth sensor feedback, the pressure sensor configured to generate, when coupled to or near the valve in a closed position and in a passing condition, the sixth sensor feedback;
determining, by the system, as a function of the sixth sensor feedback, a pressure fluctuation of a fluid at an outlet of the valve;
comparing, by the system, a combination of the vibration information, temperature differential, and the pressure fluctuation to the at least one threshold;
determining, as a function of the comparing, that the combination satisfies the at least one threshold.

15. A system, comprising:
one or more computers and one or more storage devices on which are stored instructions that are operable, when executed by the one or more computers, to cause the one or more computers to perform operations comprising:
receive first sensor feedback from a sensor attached to a valve in a closed position and in a passing condition, the first sensor feedback comprising vibration information of the valve;
receive second sensor feedback from a plurality of sensors coupled to the valve in the closed position and in the passing condition;
determine, as a function of the second sensor feedback, a temperature differential between an inlet of the valve and an outlet of the valve;
compare a combination of the vibration information and temperature differential to at least one threshold;
determine, as a function of the comparison, that the combination satisfies the at least one threshold; and
provide, to a receiver and as a function of determining that the combination satisfies the threshold, information comprising an indication of a valve passing condition.
